(19) United States
(12) Patent Application Publication
(10) Pub. No.: US 2015/0188105 A1
(43) Pub. Date: Jul. 2, 2015

(54) BATTERY MODULE

(71) Applicants: UER Technology (SHENZHEN) LIMITED, Shenzhen (CN); UER Technology Corporation, Miaoli County (TW)

(72) Inventors: RAY-TANG SUN, Miaoli (TW); TSUNG-HSIEN CHUANG, Miaoli (TW); CHENG-GHI FANG, Miaoli (TW); WEN-HSIEN CHEN, Miaoli (TW)

(21) Appl. No.: 14/573,241

(22) Filed: Dec. 17, 2014

(30) Foreign Application Priority Data
Dec. 31, 2013 (TW) 102149357

(51) Int. Cl. H01M 2/10

(52) U.S. Cl. CPC H01M 2/1094; H01M 2/1016

(57) ABSTRACT

A battery module includes a base, a battery assembly supported by the base, and a least one liquid-adsorbing member. The battery assembly contains liquid electrolyte. The least one liquid-adsorbing member is positioned between the base and the battery assembly to absorb the electrolyte if the electrolyte leaks from the battery assembly.

### CROSS-REFERENCE TO RELATED APPLICATIONS

This application is related co-pending U.S. patent applications of Attorney Docket No. US54738, US54739, and US54740, each entitled “BATTERY MODULE”, and each invented by Sun et al. These applications have the same assignee as the present application.

The above-identified applications are incorporated herein by reference.

### FIELD

The present disclosure relates to a battery module including a plurality of battery cells.

### BACKGROUND

Electrolyte leakage is a typical issue of battery modules after a long period of use or being damaged. Electrolyte leakage can damage other elements of the battery modules and causes pollutions. An effective solution of electrolyte leakage is needed.

### BRIEF DESCRIPTION OF THE DRAWINGS

Implementations of the present technology will now be described, by way of example only, with reference to the attached figure.

FIG. 1 is an exploded, isometric view of a battery module according to an exemplary embodiment.

FIG. 2 is assembled, isometric view of the battery module of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising,” when utilized, means “including, but not necessarily limited to”; it specifically indicates open-ended inclusion or membership in the so-described combination, group, series and the like.

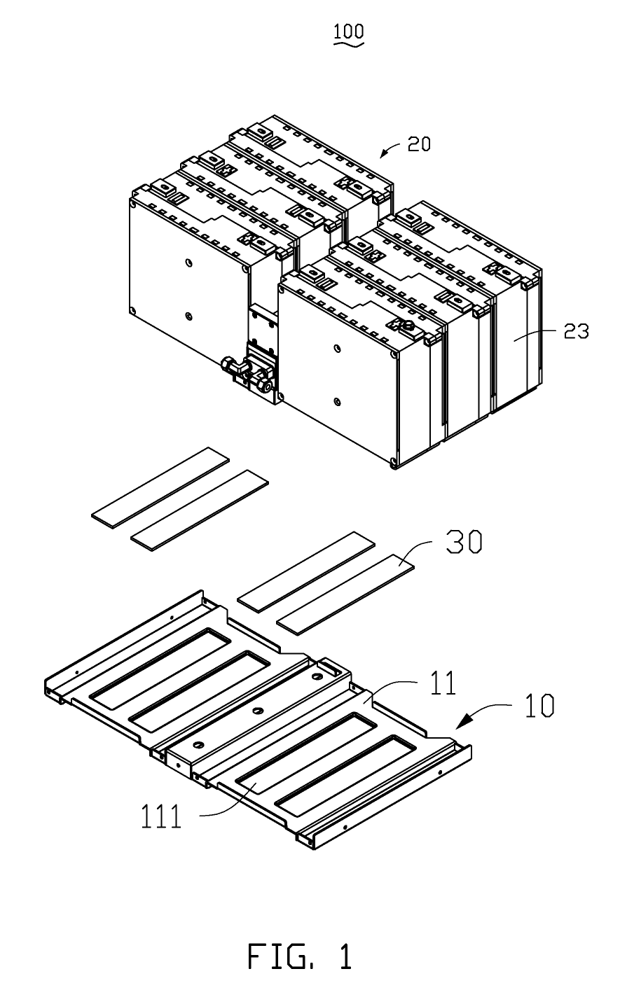

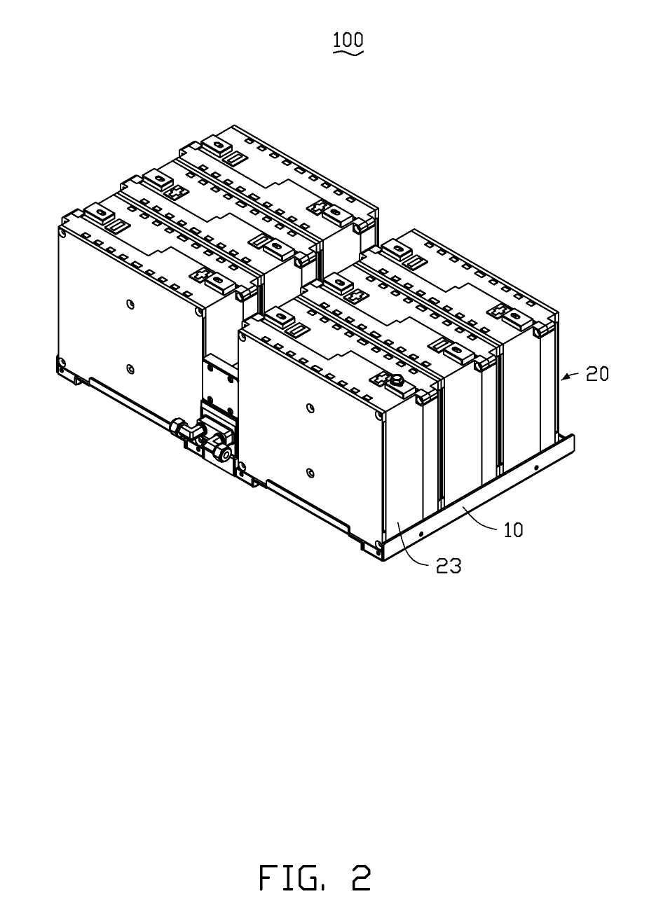

FIGS. 1 and 2 illustrate a battery module 100 comprising a base 10, a battery assembly 20 supported by the base 10, and at least one liquid-absorbing member 30. The battery assembly 20 contains liquid electrolyte. The at least a portion of one of the at least one liquid-absorbing member 30 is positioned between the base 10 and the battery assembly 20 so as to absorb any liquid electrolyte that may leak from the battery assembly 20.

The base 10 is configured to secure and support the battery assembly 20 and the at least one liquid-absorbing member 30, and other elements of the battery module 100, such as heat-dissipating elements. The base 10 comprises a support portion 11 for supporting the battery assembly 20.

The battery assembly 20 is positioned on the support portion 11. The battery assembly 20 comprises one or more battery cells 23. At least one of the one or more battery cells 23 contains liquid electrolyte. In one embodiment, the battery assembly 20 comprises a plurality of battery cells 23, and each battery cell 23 contains the liquid electrolyte. The battery cells 23 can be arranged in a matrix. In one embodiment, the battery cells 23 are arranged in a matrix having two columns and three rows. In other embodiments, the number of the row can be varied. The battery cells 23 of each column are arranged one adjacent to another.

The at least one liquid-adsorbing member 30 is positioned on the support portion 11 and is in contact with the battery assembly 20 to absorb at least some of any liquid electrolyte that may leak out of the battery cells 23. The at least one liquid-adsorbing member 30 can be made of a polymeric liquid-adsorbing material, such as vinyl acetal polymers (also known as sponge). In one embodiment, at least one receiving recess 111 is defined in the support portion 11. The at least one liquid-absorbing member 30 is received in the at least one receiving recess 111.

To assemble the battery module 100, the at least one liquid-absorbing member 30 is received in the at least one receiving recess 111. The at least one liquid-absorbing member 30 can be retained in the at least one receiving recess 111 by an adhesive. The battery assembly 20 and other elements of the battery module 100 then are mounted on the support portion 11 of the base 10, with the at least one liquid-absorbing member 30 positioned between the base 10 and the battery assembly 20.

In one embodiment, each column of the matrix of the battery cells 23 has at least one corresponding liquid-absorbing member 30 underlaying. Each of the at least one liquid-absorbing member 30 is substantially rectangular.

The embodiments shown and described above are only examples. Many details are often found in the art such as the other features of a battery module. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A battery module comprising:
a base;
a battery assembly supported by the base, the battery assembly accommodating liquid electrolyte; and
a least one liquid-adsorbing member positioned between the base and the battery assembly to absorb any electrolyte if the electrolyte leaks from the battery assembly.

2. The battery module of claim 1, wherein the base comprises a support portion for supporting the battery assembly, the at least one liquid-adsorbing member is positioned on the support portion and in contact with the battery assembly.

3. The battery module of claim 2, wherein at least one receiving recess is defined in the support portion; the at least one liquid-absorbing member is received in the at least one receiving recess.

4. The battery module of claim 1, wherein the at least one liquid-adsorbing member is made of a polymeric liquid-adsorbing material.

5. The battery module of claim 4, wherein the polymeric liquid-adsorbing material is a vinyl acetal polymer.

6. The battery module of claim 1, wherein the battery assembly comprises a plurality of battery cells; each of the battery cells contains the liquid electrolyte.

7. The battery module of claim 1, wherein the battery cells are arranged in a matrix; each column of the matrix of the battery cells has at least one liquid-absorbing member underlaying.

8. A battery module comprising:
a base;
a battery assembly supported by the base, the battery assembly comprising one or more battery cells; and
one or more liquid-absorbing members;
wherein, at least one of the one or more battery cells contains liquid electrolyte; and
wherein, at least a portion of one of the one or more liquid-absorbing members is positioned between the base and the battery assembly so as to absorb at least some of any liquid electrolyte that may leak from the one or more battery cells.

9. The battery module of claim 8, wherein the base comprises a support portion for supporting the battery assembly, the at least one liquid-adsorbing member is positioned on the support portion and in contact with the battery assembly.

10. The battery module of claim 9, wherein one or more receiving recesses are defined in the support portion; the one or more liquid-absorbing members are received in the one or more receiving recess.

11. The battery module of claim 8, wherein the one or more liquid-adsorbing members are made of a polymeric liquid-adsorbing material.

12. The battery module of claim 8, wherein the polymeric liquid-adsorbing material is a vinyl acetal polymer.
